(19) United States
(12) Patent Application Publication
(10) Pub. No.: US 2003/0081569 A1
(43) Pub. Date: May 1, 2003

(54) Method and apparatus providing call admission that favors mullti-slot mobile stations at cell edges

(75) Inventors: Thomas A. Sexton, Fort Worth, TX (US); Panayiotis D. Papadimitriou, Irving, TX (US); Hannu Vilpponen, Irving, TX (US); Prabodh Varshney, Coppell, TX (US)

Correspondence Address: HARRINGTON & SMITH, LLP, 4 RESEARCH DRIVE, SHELTON, CT, 06484-6212, US

(73) Assignee: Nokia Corporation, Espoo (FI)

(21) Appl. No.: 10/004,249

(22) Filed: Oct. 25, 2001

(51) Int. Cl. H04Q 7/00

(52) U.S. Cl. 370/329; 370/337; 370/341; 370/347; 370/431; 370/442; 370/468

(57) ABSTRACT

A cellular communications system includes a plurality of mobile stations located within at least one cell; a base transceiver station (BTS) for servicing the cell; a base station controller (BSC) coupled to the BTS; and a Call Admission processor coupled to the BTS for receiving a call admission request from mobile stations located in the cell served by the BTS. The processor, which could be co-located with the BSC, grants cellular communications system resources to mobile stations based at least in part on a level of service required by the mobile stations and on a location of the mobile stations within the cell. For a mobile station having a high bandwidth requirement and that is determined to be located at the edge of the cell, the mobile station is preferentially granted system resources by being assigned a plurality of time slots per frame for forming one radio information block, and is operated with a non-convolutional modulation format and with turbo channel coding. For example, the mobile station is operated as a rate 3/4 16-QAM mobile station at a throughput of approximately K×59.2 kbps, or as a rate 4/5 32-QAM mobile station at a throughput of approximately K×78.93 kbps, or as a rate 5/6 64-QAM mobile station at a throughput of approximately K×98.667 kbps, where K is the number of occupied time slots in the frame. The modulation format may be selected from, as examples, one of GMSK, 8-PSK, rectangular 16 gray coded QAM, 64 gray coded QAM, or 32 cross-QAM.

### TECHNICAL FIELD

These teachings relate generally to cellular telephone systems and, more specifically, relate to call admission (CA) procedures and quality of service (QoS) considerations for mobile stations.

### BACKGROUND

Typically, under a given set of channel conditions, high bandwidth RF channels are less robust, i.e., more prone to errors, than low bandwidth RF channels. As an example, a channel such as a GSM channel using a modulation scheme based on Gaussian Minimum Shift Keying (GMSK) at a code rate R will exhibit a lower frame error rate than a channel using an 8-PSK (Phase Shift Keying) modulation format at the same code rate.

As a result of this long-established knowledge it has been assumed in the cellular telephone field that high bandwidth communications are available at the center of the cell (i.e., closest to the base transceiver station (BTS)) and not at the edges of the cell.

Call Admission (CA) is a process that involves negotiating desired services with those mobile stations, such as cellular telephones, that desire admission to a certain wireless communications network, and admitting those mobile stations that maximize some criteria of the network operator, such as revenue. In accordance with the prior art, those mobile stations requesting high bandwidth services, while located at the edge of the cell, would have a high probability of being rejected, as the prevailing wisdom was that high bandwidth services were not available at the edges of the cell, or were only marginally available. As a result, the network operator could experience a loss of revenue by not admitting the high bandwidth mobile stations who happened to request admission when located away from the center of a cell, in particular those mobile stations located at the edge of the cell.

It is known in the prior art to use a Link Adaption (LA) technique to assign to those mobile stations nearer the cell edge a more powerful code than those at the center, and to use a lower bit rate. However, this solution is not always optimum, especially for mobile stations requiring a higher bit rate for data transmissions, and a call admission bias against those mobile stations located at the cell edge may still exist.

Related to the teachings of this invention is the concept of a multi-slot mobile station transmission. In a time division, multiple access (TDMA) wireless system, such as GSM, there are a plurality of time slots defined within one frame (e.g., 8 slots for GSM and 6 slots for IS-136). In order to reduce the adverse effects of burst-type noise it is well known to interleave a given radio block, such as one containing voice or other data, over some number of time slots occurring within some number of consecutive frames. For example, it is well known to interleave a given coded block of data over four time slots occurring within four consecutive TDMA frames. The four time slots are received, de-interleaved and then decoded to obtain the transmitted data block. GSM conventionally uses GMSK modulation, while more advanced versions, such as GSM-EDGE (Enhanced Data rate Global Evolution), may use 8-PSK modulation.

The interleaving and convolutional coding model was originally optimized for voice transmissions, where the data rate for voice coded (vocoded) transmissions is typically a substantially constant 10 kbits per second or less. Conventionally, a given mobile station was assigned one time slot in each consecutive frame for sending its transmissions.

This technique was subsequently enhanced to provide the mobile station with the ability to transmit in two or more time slots per frame (i.e., the mobile station was provided with multi-slot transmission capabilities. However, in order to provide a degree of backwards compatibility a given radio block was still interleaved over a set of four slots in four consecutive frames, while a second, possibly independent radio block was interleaved over a second set of four slots in the four consecutive frames. The slots from each set are then deinterleaved and decoded separately.

### SUMMARY

The foregoing and other problems are overcome by methods and apparatus in accordance with embodiments of these teachings.

In accordance with these teachings mobile stations near the cell edge that are demanding high bandwidth services are given preferential treatment as compared to those mobile stations, experiencing similar channel/energy conditions, who are requesting lower bandwidth services. Groupings of mobile stations with similar channel and energy conditions may be considered to form miniature cells or sub-cells within the larger, traditional cell. As mobile stations move from one miniature cell to another their channel allocation may change.

A cellular communications system is disclosed, as are methods for operating the cellular communications system. The system includes a plurality of mobile stations located within at least one cell; a base transceiver station (BTS) for servicing the cell; a base station controller (BSC) coupled to the BTS; and a Call Admission processor coupled to the BTS for receiving a call admission request from mobile stations located in the cell served by the BTS. The processor, which could be co-located with the BSC, grants cellular communications system resources, such as one or more of time slots, spreading codes, frequency channels and bandwidth, to mobile stations based at least in part on a level of service required by the mobile stations and on a location of the mobile stations within the cell. For a mobile station having a high bandwidth requirement and that is determined to be located at the edge of the cell, the mobile station is preferentially granted system resources by being assigned a plurality of time slots per frame for forming one radio information block, and is operated with a channel coding technique that uses an iterative decoding technique, such as turbo channel coding.

For example, the mobile station is operated as a rate 3/4 16-QAM mobile station at a throughput of approximately K×59.2 kbps, or as a rate 4/5 32-QAM mobile station at a throughput of approximately K×78.93 kbps, or as a rate 5/6 64-QAM mobile station at a throughput of approximately K×98.667 kbps, where K is the number of occupied time slots in the frame.

The modulation format may be selected from, for example, one of GMSK, 8-PSK, rectangular 16 gray coded QAM, 64 gray coded QAM, or 32 cross-QAM.

The radio information block may comprise four TDMA frames and may occupy K slots per TDMA frame. The radio information block size is thus equal to N=464×K×throughput bits, where the throughput is equal to the number of information bits per data symbol.

### BRIEF DESCRIPTION OF THE DRAWINGS

The above set forth and other features of these teachings are made more apparent in the ensuing Detailed Description of the Preferred Embodiments when read in conjunction with the attached Drawings, wherein:

FIG. 1 is a block diagram of a wireless communication system that is suitable for practicing this invention;

FIG. 2 illustrates a model of a simulation chain useful for explaining the operation of these teachings;

FIG. 3 is a block diagram of a Turbo encoder shown in FIG. 2;

FIG. 4 is a graph that illustrates the spectrum of a pulse shaping filter shown in FIG. 2;

FIG. 5 illustrates a presently preferred slot structure;

FIG. 6 is a graph that contrasts the improvement in the block error rate (BLER) that is achieved by using a four slot per frame information block (with turbo coding and a high order modulation format), as opposed to a conventional one slot information block; and

FIG. 7 is a logic flow diagram describing a call admission (CA) algorithm executed by the BSC data processor shown in FIG. 1.

### DETAILED DESCRIPTION OF THE PREFERRED EMBODIMENTS

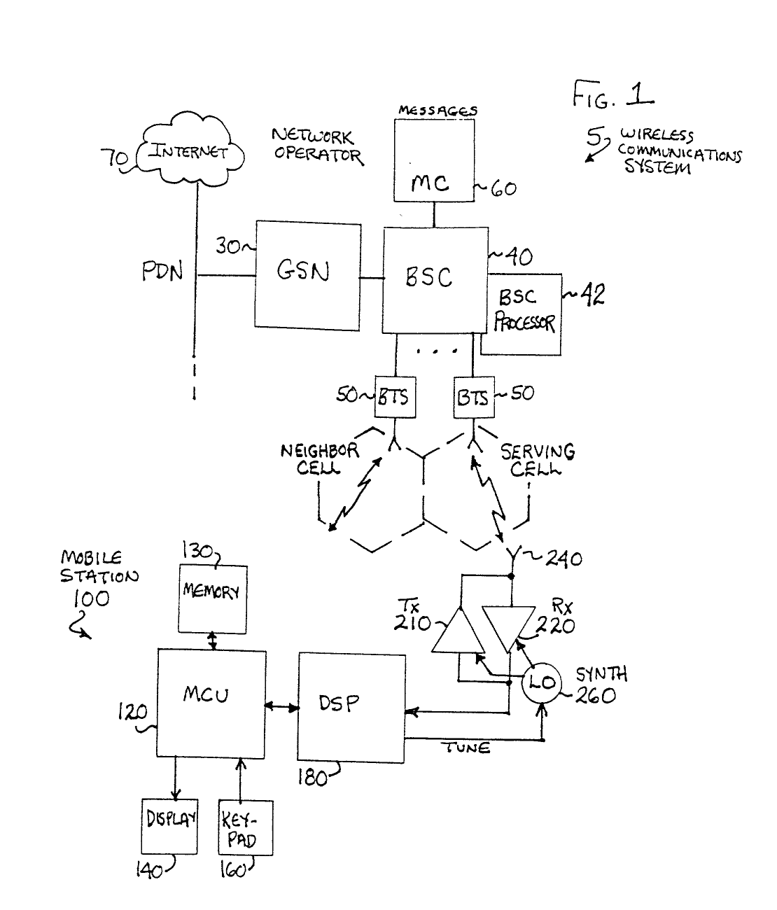

Referring first to FIG. 1, there is illustrated a simplified block diagram of an embodiment of a wireless communications system 5 that is suitable for practicing this invention. The wireless communications system 5 includes at least one mobile station (MS) 100. FIG. 1 also shows an exemplary network operator having, for example, a GPRS Support Node (GSN) 30 for connecting to a telecommunications network, such as a Public Packet Data Network or PDN, at least one base station controller (BSC) 40, and a plurality of base transceiver stations (BTS) 50 that transmit in a forward or downlink direction both physical and logical channels to the mobile station 100 in accordance with a predetermined air interface standard. A reverse or uplink communication path also exists from the mobile station 100 to the network operator, which conveys mobile originated access requests and traffic.

Each BTS 50 supports a cell. For any given location of the MS 100 there will be a cell that currently supports the MS 100 (the serving cell), and at least one neighbor cell that may become the next serving cell. The MS 100 may be located at any position within the serving cell, such as at the cell edge. For the purposes of this description the cell edge may be defined to be the region or area around the perimeter of the cell where some percentage (e.g., 90%) of the mobile stations located therein operate at a minimally acceptable amount of frame errors. The 90% figure is somewhat arbitrary, and is determined to a large degree by the requirements of the network operator.

The BSC 40 is assumed for the purposes of this invention to include a data processor 42 that operates under the control of a stored program to control the various BTS 50 and to interface with various ones of the MSs 100 located in the cells supported by the various BTS 50. Of most concern to these teachings is the execution of a Call Admission (CA) algorithm for the various MSs 100 located in the cells supported by the BTSs 50. The presently preferred CA algorithm will be described in further detail below.

It is noted that while the CA algorithm may preferably be executed by the BSC 40, in other embodiments the CA algorithm could be executed by the GSN 30, or by a mobile switching center (MSC, not shown), or by any suitable node or combinations of nodes in the wireless communication system 5.

The air interface standard can conform to any suitable standard or protocol, and may enable both voice and data traffic, such as data traffic enabling Internet 70 access and web page downloads. In the presently preferred embodiment of this invention the air interface standard is a Time Division Multiple Access (TDMA) air interface that supports a GSM or an advanced GSM protocol and air interface, although these teachings are not intended to be limited to TDMA or to GSM or GSM-related wireless systems. For example, these teachings may apply as well to some Code Division Multiple Access (CDMA) systems.

The network operator may also include a suitable type of Message Center (MC) 60 that receives and forwards messages for the mobile stations 100. Other types of messaging service may include Supplementary Data Services and one under currently development and known as Multimedia Messaging Service (MMS), wherein image messages, video messages, audio messages, text messages, executables and the like, and combinations thereof, can be transferred between the network and the mobile station 100.

The mobile station 100 typically includes a microcontrol unit (MCU) 120 having an output coupled to an input of a display 140 and an input coupled to an output of a keyboard or keypad 160. The mobile station 100 may be a handheld radiotelephone, such as a cellular telephone or a personal communicator. The mobile station 100 could also be contained within a card or module that is connected during use to another device. For example, the mobile station 10 could be contained within a PCMCIA or similar type of card or module that is installed during use within a portable data processor, such as a laptop or notebook computer, or even a computer that is wearable by the user.

The MCU 120 is assumed to include or be coupled to some type of a memory 130, including a read-only memory (ROM) for storing an operating program, as well as a random access memory (RAM) for temporarily storing required data, scratchpad memory, received packet data, packet data to be transmitted, and the like. A separate, removable SIM (not shown) can be provided as well, the SIM storing, for example, a preferred Public Land Mobile Network (PLMN) list and other subscriber-related information. The ROM is assumed, for the purposes of this invention, to store a program enabling the MCU 120 to execute the software routines, layers and protocols required to implement the methods in accordance with these teachings, as well as to provide a suitable user interface (UI), via display 140 and keypad 160, with a user. Although not shown, a microphone and speaker are typically provided for enabling the user to conduct voice calls in a conventional manner.

The mobile station 100 also contains a wireless section that includes a digital signal processor (DSP) 180, or equivalent high speed processor or logic, as well as a wireless transceiver that includes a transmitter 200 and a receiver 220, both of which are coupled to an antenna 240 for communication with the network operator. At least one local oscillator (LO) 260, such as a frequency synthesizer, is provided for tuning the transceiver to different GSM channels (in GSM the transmit and receive channels are on different frequencies.) Data, such as digitized voice and packet data, is transmitted and received through the antenna 240.

The MS 100 is assumed, for the purposes of this invention, to support multi-slot operation, and to support the use of an iterative decoding process, such as a Turbo Code, as well as possibly a higher level modulation format than the conventional GSM GMSK convolutional modulation format. For example, the DSP 180 of the MS 100 may be programmed so as to implement and support at least GMSK and 8-PSK modulation formats.

In a first publication entitled Turbo Coded Modulation for High-Throughput TDMA Systems, by P. D. Papadimitriou and P. Varshney, Proc. of IEEE VTC, May 2001, two of the inventors reported on an improvement in data throughput that can be achieved by the use of a strong coding scheme, such as a Turbo Code, in combination with the use of higher level modulation such as 16/64 QAM and an increase in the block size (e.g., four slots per eight slot GSM frame). It was shown that in a fading channel the most critical parameter for gaining a performance increase, as measured by the Block Error Rate (BLER), is the increased block size, and not the number of iterations, and hence the complexity, of the selected turbo code. The disclosure of this first publication is incorporated by reference herein in its entirety.

In a second publication entitled Turbo Coded Modulation Over GSM Channels, 2001 International Conference on Third Generation Wireless and Beyond, June 2001, P. D. Papadimitriou, T. A. Sexton, P. Varshney and H. Vilpponen, the present inventors discuss a turbo-coded high level modulation system (16/32/64 QAM) for use on the downlink (BTS 50 to MS 100), and evaluate the performance in GSM channels. The maximum throughput is shown to be, using a rate 5/6 64-QAM approach, approximately K×98.667 kbps for a mobile station occupying K slots in the GSM frame. The disclosure of this second publication is also incorporated by reference herein in its entirety.

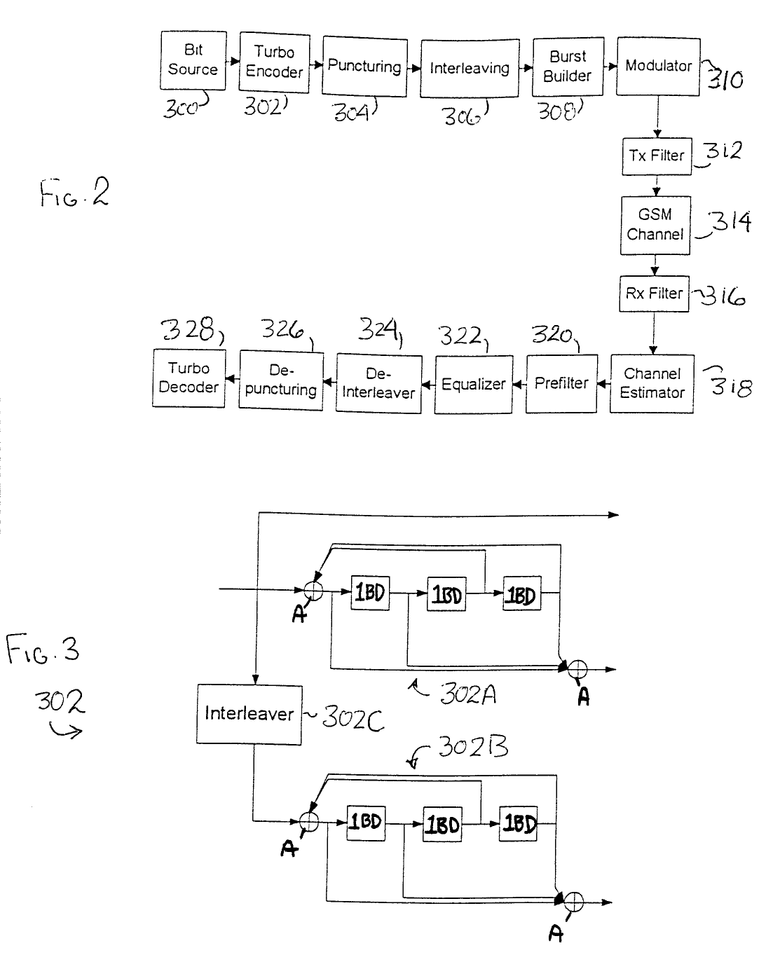

By way of example, FIG. 2 shows a simulation chain discussed in the second publication discussed above. The simulation chain, which may also be viewed as a block diagram of a transmit/receive chain of the wireless communications system 5, proceeds from a bit source 300 to a turbo encoder 302, and thence to a puncturing block 304, slot interleaving block 306, burst builder block 308, modulator 310, transmit (TX) filter 312, GSM channel 314, receiver (RX) filter 316, channel estimator 318, prefilter 320, equalizer 322, de-interleaver 324, depuncturing block 326, and finally to a corresponding turbo decoder 328. In this non-limiting embodiment the turbo encoder 302, of rate 1/3, is a parallel concatenated convolutional code (PCCC). FIG. 3 is a simplified block diagram of the turbo encoder 302 and shows, by way of example and not as a limitation upon the practice of this invention, that the turbo encoder 302 includes two 8-state identical recursive systematic convolutional encoders (13₈,15₈) designated 302A, 302B that are combined in parallel through an S pseudo-random bit interleaver 302C. In general, any pseudo-random interleaver can be used in the turbo code. Parity bit puncturing is employed in block 304 to obtain overall code rates from 3/4 up to 5/6 (assuming, for example, the use of 16-QAM through 64-QAM, as shown below in Table 1.) In FIG. 3 the blocks labeled 1BD are one bit delays and the adders (A) are modulo two adders.

General reference with regard to turbo codes can be made to D. Divsalar and F. Pollara, Turbo Codes for PCS Applications, pp. 54-59, Proc. IEEE ICC, 1995; C. Berrou, A. Glavieux, and P. Thitimajshima, Near Shannon Limit Error-Correcting Coding and Decoding: Turbo Codes, pp. 1064-1070, Proc. of IEEE ICC, 1993; S. Le Goff, A. Glavieux, and C. Berrou, Turbo-Codes and High Spectral Efficiency Modulation, pp. 645-649, Proc. of IEEE ICC, 1994; and to S. Le Goff, Performance of bit-interleaved turbo-coded modulations on Rayleigh fading channels, Electronics Letters, Vol. 36, No. 8, pp. 731-733, April 2000.

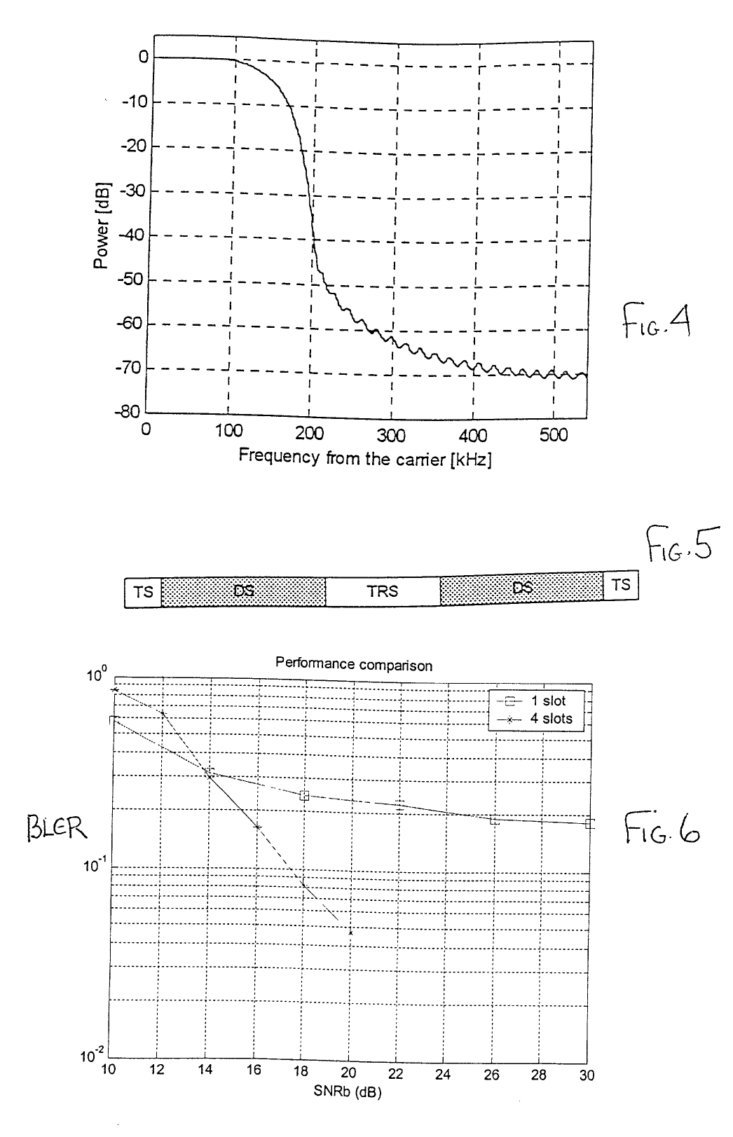

A form of pseudo-random channel bit interleaving is employed in block 306 to break the correlation of the channel. The symbols selected from the QAM constellation are filtered using a root raised cosine filter, with roll off factor 0.4 and 61 taps. The power spectrum of the pulse shaping filter is given in FIG. 4 for a measurement bandwidth of 30 kHz. The modulations used are, by example, rectangular 16 and 64 gray coded QAM, and 32 cross-QAM.

At the receiver, an LMMSE (Linear Minimum Mean Square Error) channel estimator 318 is employed. Since it is desirable to model the performance over the typical urban (TU) and rural area (RA) channels, the channel is modeled (from the channel estimator 318 perspective) as a 4^{th} order symbol-spaced Finite Impulse Response (FIR) filter. For these channels all the path delays are concentrated around the first symbol period interval. The symbol period is 3.692 microseconds, and the carrier frequency is 900 MHz. A MMSE (Minimum Mean Square Error) prefilter 320 is used after the channel estimator 318 and prior to a reduced-state equalizer 322. The equalizer 322 employed is a soft-output DFSE (Decision Feedback Sequence Estimator) having M MLSE (Maximum Likelihood Sequence Estimator) states, and M³ DFE (Decision Feedback Equalizer) states, where M is the number of the modulation levels. This type of equalizer is not a limitation upon the practice of these teachings. The equalizer outputs are de-interleaved (324), de-punctured (326) and fed to the MAP turbo decoder (328).

The complexity of the turbo coding scheme with 3 decoding iterations is less than the complexity of a 256-state (rate 1/2) convolutional code employing the Viterbi algorithm for decoding.

The slot structure used may be one similar to the EGPRS, and is described in detail in the first publication referred to above, and shown as well in FIG. 5. The slot structure is comprised of 3+3 tail symbols (TS), 58+58 data symbols (DS) and a 26-symbol wide training sequence. In the illustrative embodiment, in the DS part of the slot both headers and data symbols are handled as user data (performance wise). Each radio block preferably makes use of 4 TDMA frames (8 slots compose a GSM TDMA frame) and it is assumed that a user occupies K slots per TDMA frame. Therefore the block size is equal to N=464×K×throughput bits, where the throughput is defined as the number of information bits per data symbol, i.e. for rate 3/4 16-QAM the throughput is 3 bits/symbol. The maximum information data rates that can be achieved with the presently preferred embodiment are shown below in Table 1.

TABLE 1
Maximum information data rates

| Rate | Modulation | Data Rate |
|---|---|---|
| 3/4 | 16-QAM | 473.6 kbps |
| 4/5 | 32-QAM | 631.5 kbps |
| 5/6 | 64-QAM | 789.3 kbps |

Since this presently preferred system employs Turbo coding, it is advantageous to use as large blocks as possible to maximize the coding gain. This also increases the channel bit interleaver's size, which is important to obtain good performance of the system over fading channels. The existing EGPRS system has defined the multi-slot mobile. A user, in order to achieve higher throughput, can occupy multiple slots in the same TDMA frame. In order to take advantage of this capability the entire resulting information block is encoded. In contrast, in the current EGPRS system the information blocks to be encoded correspond to only one slot per TDMA frame.

In the foregoing Table 1 the Data Rates assume the maximum number of time slots that are occupied by the MS 100 (i.e., all eight slots for the GSM case). The 16-QAM example generalizes to a throughput of approximately K×59.2 kbps, where K is the number of occupied time slots in the frame; the 32-QAM example generalizes to a throughput of approximately K×78.93 kbps, where K is the number of occupied time slots in the frame; and the 64-QAM example generalizes to a throughput of approximately K×98.67 kbps, where K is the number of occupied time slots in the frame.

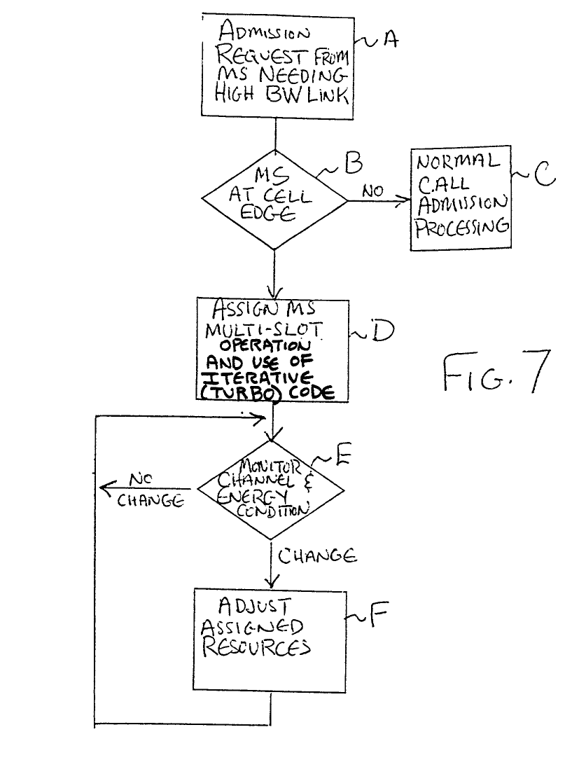

Further now in accordance with this invention the CA algorithm executed by the BSC processor 42 operates to selectively give preference to certain MSs 100 located at the cell edge (those requesting or requiring higher bandwidth) by assigning to these mobile stations larger frame sizes (e.g., four slots per frame) and turbo coding using parallel and/or serial concatenated codes. The resulting increase in coding gain leads to a lower required Eb/No and reduction in the BLER, as is made evident in the graph contrasting one slot versus four slot operation shown in FIG. 6.

This significant enhancement in performance is exploited by the BSC data processor 42 when executing the Call Admission (and possibly Link Adaptation) algorithm so as to preferentially assign channels to those cell-edge located MSs 100 that require high bandwidth service and/or that have other demanding QoS requirements, the assignment being: (i) multiple slots per frame (e.g., 4 slots per frame); and (ii) a turbo code using parallel and/or serial concatenated codes, or, in general, any code using iterative decoding techniques.

As employed herein iterative decoding is a process of decoding a channel in which a first coding pass produces soft information. This soft information is then processed along with the original soft input signal by another decoding module or by the same decoding module. Each repetition of this decoding improves the reliability of the soft information output, in practice with diminishing improvement as the number of iterations increases. Reference in this regard may be had to a publication by R. J. McEliece, D. J. C. MacKay and J. -F. Cheng, Turbo Decoding as an Instance of Pearl's “Belief Propagation” Algorithm, IEEE Journal on Selected Areas in Communications, Vol. 16, No. 2, February 1998.

In the specific case of the parallel turbo decoder 328 of the preferred embodiment of this invention, the soft information is exchanged between the constituent decoders after each iteration.

While described primarily in the context of a turbo code, it should be noted that the iterative decoder is not limited to one based on a turbo code. For example, another type of iterative decoder is one based on a Low Density Parity Check (LDPC) code (see, for example, the publication by M. P. C. Fossorier, Iterative Reliability-Based Decoding of Low-Density Parity Check Codes, IEEE Journal on Selected Areas in Communications, Vol. 19, No. 5, May 2001.)

In general, increasing the block length when using a turbo code provides a gain. Reference in this regard can be had to pages 593 through 595 of S. Benedetto and G. Montorsi, Design of Parallel Concatenated Convolution Codes, IEEE Transactions of Communications, Vol. 44, No. 5, pp. 591-600, May 1996.

Referring to FIG. 7, at step A the data processor receives an admission request from a MS 100. The request will typically include, or will result in the BSC 40 determining, what the QoS requirements of the MS 100 are, including the required bandwidth and possibly a minimum acceptable BER or BLER. At step B, for a MS 100 requesting a high bandwidth connection, the data processor 42 makes a determination, based on the output of a mobile station location function (e.g., one based on Global Positioning System (GPS), or one based on Observed Time Difference (OTD)) whether the MS 100 is located at the cell edge. If the result is negative, then processing continues at step C in accordance with conventional CA and LA practice. However, if the result is positive then processing continues at step D in accordance with the teachings of this invention to assign to the MS 100 (for the uplink and/or the downlink): (i) multiple slots per frame (e.g., 4 slots per frame); and (ii) a turbo code using parallel and/or serial concatenated codes (or some other code using iterative decoding techniques.) The MS 100 is thus equipped to bidirectionally communicate with the BTS 50, while maintaining an acceptably low BLER.

Note should be made that the data processor 42 may preferentially grant call admission and assign resources to the MS 100 requesting a high bandwidth data link, as opposed to granting these resources to one or more other mobile stations 100, located anywhere within the cell, that desire only lower quality voice channels. This determination can be made based on any number of suitable criteria, such as the difference in revenue derived from the various types of links, the number of available channels, the amount of available bandwidth, the channel quality at the cell edge (e.g., the link margin, presence of interference source(s), etc.).

In the presently preferred embodiment at step E the data processor 42 continues to monitor the channel conditions and energy levels of the admitted MSs 100, and also continues to monitor the bandwidth requirements of the various users. Those mobile stations 100 located at the cell edge may be viewed as occupying sub-cells of the cell, and may be monitored and managed as such. When channel conditions change and/or the user bandwidth and QoS requirements change then at step F the radio resources assigned to a particular MS 100 can be adjusted. As an example, if the bandwidth requirements of a MS 100 that was admitted as a user requiring a high bandwidth connection have decreased significantly, then one or more assigned slots may be taken from this user and assigned to another user. It is also possible that the MS 100 is no longer located at the cell edge, but has since moved to a location within the cell with different radio conditions. In this case the MS 100 maybe commanded to do any one of several things.

For example, link adaptation is a process that depends on the minimum throughput acceptable to the mobile station, available radio resources, instantaneous SNR (signal to noise ratio) at the mobile station, as well as recent block error history. The MS 100 may thus cease to be operated as a multi-slot mobile station, and may be commanded to revert to conventional operation (e.g., transmission in a single time slot, or transmission over multiple time slots with individually encoded blocks per time slot.) Or the MS 100 may continue in multi-slot operation, but with a different modulation and coding scheme.

It can be appreciated that a MS 100 originating an emergency voice call at the cell edge may be preferentially treated in the same manner as a MS 100 requesting a high bandwidth connection, and may thus be granted high performance multi-slot capability as discussed above to increase the probability that the call will be successfully connected and maintained.

The foregoing teachings may be applied as well to groups of mobile stations requesting entry to a congested cell during a handoff (HO). Further with regard to handoff, it is within the scope of these teachings for the MS 100 to retain its assigned resources, if possible, when transitioning from cell edge to cell edge.

In general, it should be appreciated that the application of the above-described call admission algorithm is not limited to those mobile stations located at the cell edge. For example, when multi-slot performance exceeds single slot performance, and more users request access than can be served, the call admission algorithm may operate to favor the multi-slot mobile station(s) desiring access.

Also, and as was discussed above, systems that use codes other than turbo codes can benefit from the teachings of this invention. Preferably, the coder/decoder pair is one that operates by an iterative decoding technique.

While these teachings have been particularly shown and described with respect to preferred embodiments thereof, it will be understood by those skilled in the art that changes in form and details may be made therein without departing from the scope and spirit of these teachings.

What is claimed is:

1. A method for granting system access to mobile stations, comprising:
receiving a call admission request from a mobile station at the edge of a cell; and
granting system resources to the mobile station based at least in part on a bandwidth requirement of the mobile station, wherein for a mobile station having a high bandwidth requirement, the mobile station is preferentially granted system resources by being assigned a plurality of time slots per frame for forming one radio information block, and is operated with a coding technique that employs an iterative decoding technique.

2. A method as in claim 1, wherein the mobile station is operated as a rate 3/4 16-QAM mobile station at a throughput of approximately K×59.2 kbps, where K is the number of occupied time slots in the frame.

3. A method as in claim 1, wherein the mobile station is operated as a rate 4/5 32-QAM mobile station at a throughput of approximately K×78.93 kbps, where K is the number of occupied time slots in the frame.

4. A method as in claim 1, wherein the mobile station is operated as a rate 5/6 64-QAM mobile station at a throughput of approximately K×98.667 kbps, where K is the number of occupied time slots in the frame.

5. A method as in claim 1, wherein the modulation format is selected from one of GMSK, 8-PSK, rectangular 16 gray coded QAM, 64 gray coded QAM, and 32 cross-QAM.

6. A method as in claim 1, wherein the radio information block comprises four TDMA frames and occupies K slots per TDMA frame, wherein the radio information block size is equal to N=464×K×throughput bits, where the throughput is equal to the number of information bits per data symbol.

7. A cellular communications system, comprising:
a plurality of mobile stations located within at least one cell;
a base transceiver station (BTS) for servicing said cell;
a base station controller (BSC) coupled to said BTS; and
a Call Admission processor coupled to said BTS for receiving a call admission request from mobile stations located in the cell served by said BTS, said processor granting cellular communications system resources to the mobile stations based at least in part on level of service required by the mobile stations and on a location of the mobile stations within the cell, wherein for a mobile station having a high bandwidth requirement that is determined to be located at the edge of the cell, the mobile station is preferentially granted system resources by being assigned a plurality of time slots per frame for forming one radio information block, and is operated with a coding technique that employs an iterative decoding technique.

8. A cellular communications system as in claim 7, wherein the mobile station is operated as a rate 3/4 16-QAM mobile station at a throughput of approximately K×59.2 kbps, where K is the number of occupied time slots in the frame.

9. A cellular communications system as in claim 7, wherein the mobile station is operated as a rate 4/5 32-QAM mobile station at a throughput of approximately K×78.93 kbps, where K is the number of occupied time slots in the frame.

10. A cellular communications system as in claim 7, wherein the mobile station is operated as a rate 5/6 64-QAM mobile station at a throughput of approximately K×98.667 kbps, where K is the number of occupied time slots in the frame.

11. A cellular communications system as in claim 7, wherein the modulation format is selected from one of GMSK, 8-PSK, rectangular 16 gray coded QAM, 64 gray coded QAM, and 32 cross-QAM.

12. A cellular communications system as in claim 7, wherein the radio information block comprises four TDMA frames and occupies K slots per TDMA frame, wherein the radio information block size is equal to N=464×K×throughput bits, where the throughput is equal to the number of information bits per data symbol.

13. A cellular communications system as in claim 7, wherein the iterative coding technique comprises a turbo code, said turbo code being implemented with two n-state identical recursive systematic convolutional encoders (13₈,15₈) that are combined in parallel through a pseudo-random bit interleaver.

14. A method for granting system access to mobile stations, comprising:
receiving a call admission request from a mobile station;
granting system resources to the mobile station based at least in part on a bandwidth requirement of the mobile station and on a location of the mobile station within the cell, wherein for a mobile station having a high bandwidth requirement that is located at the cell edge, the mobile station is preferentially granted system resources by being assigned a plurality of time slots per frame for forming one radio information block, and by being operated with a coding technique that employs an iterative decoding technique; and
monitoring changes in the location and the system resource requirements of the mobile station and varying the granted system resources accordingly.

15. A method as in claim 14, wherein a modulation format is selected from one of GMSK, 8-PSK, rectangular 16 gray coded QAM, 64 gray coded QAM, and 32 cross-QAM.

16. A method as in claim 14, wherein the radio information block comprises four TDMA frames and occupies K slots per TDMA frame, wherein the radio information block size is equal to N=464×K×throughput bits, where the throughput is equal to the number of information bits per data symbol.

17. A method as in claim 14, wherein the coding technique comprises at least one of parallel or serial concatenated code turbo channel coding.

18. A method for operating a call admission function in a cellular communications system, comprising:
receiving a call admission request from a mobile station located in a cell; and
granting system resources to the mobile station based at least in part on a bandwidth requirement of the mobile station, wherein for a mobile station having a high bandwidth requirement, the mobile station is preferentially granted system resources by being assigned a plurality of time slots per frame for conveying one radio information block, and is operated with a coding technique that employs an iterative decoding technique.

19. A method as in claim 18, wherein the mobile station is located at the cell edge, and further comprising adjusting the granted system resources as the mobile station changes its location within the cell, and retaining the granted system resources as the mobile station transitions to an edge of another cell.

20. A method as in claim 18, wherein the iterative decoding technique uses a turbo code.
